(19) United States
(12) Patent Application Publication
(10) Pub. No.: US 2025/0200886 A1
(43) Pub. Date: Jun. 19, 2025

(54) SYSTEMS AND METHODS FOR DIGITAL SURFACE MODEL RECONSTRUCTION FROM IMAGES USING ARTIFICIAL INTELLIGENCE

(71) Applicant: Eagle View Technologies, Inc., Rochester, NY (US)

(72) Inventors: Bishwarup Bhattacharjee, Kolkata (IN); Bollampally Bharat Kumar Reddy, Sanjay Gandhi nagar (IN); Harini Narasimhan, Poonamallee (IN); Shivam Kumar, Begusarai (IN); Ravindra Kulkarni, Airoli Navi Mumbai (IN); Shubham Goyal, New Delhi (IN); Nitin Aggarwal, Noida (IN)

(21) Appl. No.: 18/847,061

(22) PCT Filed: Mar. 15, 2023
(86) PCT No.: PCT/US2023/064410

§ 371 Date: Sep. 13, 2024

Related U.S. Application Data
(60) Provisional application No. 63/320,026, filed on Mar. 15, 2022.

(51) Int. Cl. G06T 17/05; G06T 7/00

(52) U.S. Cl. CPC G06T 17/05; G06T 7/97; G06T 2207/10032; G06T 2207/20081; G06T 2207/20084; G06T 2207/30184

(57) ABSTRACT

Systems and methods for creating digital surface models (DSMs) are disclosed, including a method comprising generating, with machine learning algorithm(s), a candidate DSM of a first geographic area with first image(s) from a set of first images depicting a first characteristic, the candidate DSM having voxels identifying a location within the first geographic area and having an elevation value; comparing elevation values for voxels of the candidate DSM to corresponding elevation values for voxels of a predetermined DSM, created with a set of second images of the first geographic area having a second characteristic including features beyond that provided with the set of first images, to determine error; adjusting, via back-propagation, the machine learning algorithm(s) based on the determined error; and generating with the trained machine learning algorithm(s), a DSM using a set of third images depicting a second geographic area.

### CROSS-REFERENCE TO RELATED APPLICATIONS

This application claims priority to the U.S. provisional patent application identified by Ser. No. 63/320,026, filed Mar. 15, 2022, titled “Systems and Methods for Digital Surface Model Reconstruction from Images Using Artificial Intelligence”, the contents of which are hereby incorporated in their entirety herein.

### FIELD OF THE DISCLOSURE

The disclosure generally relates to methods and systems for reconstruction of Digital Surface Models. More particularly the disclosure relates to utilizing artificial intelligence for the analysis of images to generate Digital Surface Models. In some implementations, the systems and methods utilize artificial intelligence to reconstruct Digital Surface Models from images such that the Digital Surface Models include predetermined types of features or characteristics beyond the types of features or characteristics depicted or not depicted in the images. In some implementations, the images are not required to be part of stereo pairs.

### BACKGROUND

Digital Surface Models (DSMs) are computer-based models of the surface of a geographic area, which may include objects in the geographic area. Digital Surface Models are used in many different technical fields, including for computer-based determinations that may be used for the construction and repair of private residences and/or commercial buildings. Additionally, Digital Surface Models may be very helpful in conjunction with solar data in computer-based determination of the solar potential of a private residence or commercial building. For example, Digital Surface Models may be used in combination with data about a roof of a building (such as measurements and/or area of the roof) to estimate the Solar Access Values that the roof receives at different points on the roof and/or at different times throughout the day or different times during the year.

There are many ways to capture points for creating Digital Surface Models. Two exemplary methods that may be used to determine points for creating Digital Surface Models are LIDAR (Light Detection and Ranging) and stereo photogrammetry.

However, while Digital Surface Models created from LiDAR data have a high precision, the creation is computer-resource intensive and cost intensive. Further, generating Digital Surface Models through stereo photogrammetry requires paired images (“stereo-pairs”) of the same geographical region, which may not be available and may require additional resources to acquire.

Additionally, LiDAR scanning and image capture of a geographic areas are resource intensive and cost intensive and may be performed infrequently or only at specific times of the year, for example. Because of this, the resulting conventional Digital Surface Models only show features present, or absent, in the captured LiDAR or images at a particular point in time when the data is captured.

For example, images that are captured of deciduous vegetation in winter show no foliage present on the vegetation, while images that are captured of deciduous vegetation in summer show foliage present. As a result, a Digital Surface Model created from images captured in winter may be significantly different than a Digital Surface Model created from images captured in summer.

In this example, if the Digital Surface Model created based on images captured during the winter is then used to determine the effect of vegetation on shading structures, the resulting determination may be inaccurate, depending on the time of year. For example, if a Digital Surface Model represents trees without leaves, then during summer months when trees have leaves, using the Digital Surface Model for determining solar access would not take into account the shading caused by the leaves. Further, capturing the images in multiple seasons is resource and cost intensive.

Because of these problems, there is a need for computer-based methods and systems that generate Digital Surface Models without relying on LiDAR or stereo photogrammetry, and further need for computer-based systems and methods that can produce Digital Surface Models that depict desired features or characteristics that are beyond those, or less than those, depicted in the images used in creating the Digital Surface Model.

### SUMMARY

Methods and systems are disclosed for Digital Surface Model reconstruction from images using artificial intelligence. The problems of Digital Surface Model reconstruction from stereo-images or LiDAR are addressed through systems and methods to generate Digital Surface Models of objects, such as vegetation, structures, buildings, and roofs, using digital images (which may be referred to as simply images) that are not required to be stereo pairs. Further, the systems and methods may be configured to generate Digital Surface Models that estimate features of objects and/or characteristics of objects that a user desires to be modeled, but that are not depicted in the images or data used to generate the Digital Surface Model. The systems and methods may be configured to generate Digital Surface Models of surfaces in images that do not include features of objects and/or characteristics of objects that a user desires not to be modeled, but that are depicted in the images or data used to generate the Digital Surface Model.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a schematic of an exemplary system for creating Digital Surface Models, in accordance with the present disclosure.

FIG. 2 is a schematic of an exemplary non-transitory computer medium, in accordance with the present disclosure.

FIG. 3 is an illustration of a capture platform capturing an image from a nadir perspective, in accordance with the present disclosure.

FIG. 4 is an illustration of a capture platform capturing an image from an oblique perspective, in accordance with the present disclosure.

FIG. 5 is a diagram of an exemplary generation of a candidate Digital Surface Model of a first geographic area, in accordance with the present disclosure.

FIG. 6 is a diagram of an exemplary machine learning model, in accordance with the present disclosure

FIG. 7 is a diagram of an exemplary generation of a Digital Surface Model of a second geographic area, in accordance with the present disclosure.

FIG. 8 is a process flow chart of an exemplary method for creating Digital Surface Models, in accordance with the present disclosure.

FIG. 9 is a process flow chart of an exemplary method for creating Digital Surface Models, in accordance with the present disclosure.

FIG. 10 is an exemplary input and result of an exemplary method for creating Digital Surface Models, in accordance with the present disclosure.

FIG. 11 is another exemplary input and result of an exemplary method for creating Digital Surface Models, in accordance with the present disclosure.

FIG. 12 is an exemplary result of the use of a Digital Surface Model produced by an exemplary method for creating digital surface models, in accordance with the present disclosure.

FIG. 13 is another exemplary result of the use of a Digital Surface Model produced by an exemplary method for creating digital surface models, in accordance with the present disclosure.

### DETAILED DESCRIPTION

The following detailed description refers to the accompanying drawings. The same reference numbers in different drawings may identify the same or similar elements.

The mechanisms proposed in this disclosure circumvent the problems described above. The present disclosure describes systems and methods for reconstruction of Digital Surface Models utilizing artificial intelligence, such as machine learning, which may utilize images as input, in which the images are not required to be stereo pairs, and which may result in Digital Surface Models that depict features or characteristics not depicted in the images or that do not depict features or characteristics that are depicted in the images.

In one exemplary implementation, a system for creating DSMs may comprise one or more non-transitory computer readable medium storing computer executable code that when executed by one or more computer processors causes the one or more computer processors to:
a. generate, with one or more machine learning algorithms, a candidate Digital Surface Model of a portion of a first geographic area with one or more first images from a set of first images, the candidate Digital Surface Model having a plurality of voxels with at least some of the voxels identifying a location within the first geographic area and having an elevation value, the set of first images depicting at least a portion of the first geographic area with a first characteristic;
b. compare elevation values for voxels of the candidate Digital Surface Model to corresponding elevation values for voxels of a predetermined Digital Surface Model of the first geographic area to determine an error for the voxels of the candidate Digital Surface Model, the predetermined Digital Surface Model created with a set of second images of the first geographic area having a second characteristic including features beyond that provided with the set of first images having the first characteristic;
c. adjust, via back-propagation, the one or more machine learning algorithms based on the determined error for the voxel of the candidate Digital Surface Model; and
d. repeat a. b. and c. until the determined errors for the voxels is below a predetermined threshold indicating trained machine learned algorithms.

The computer executable code, when executed by the one or more computer processors, may cause the one or more computer processors to generate with the trained machine learning algorithms, a new Digital Surface Model using a set of third images depicting a second geographic area.

In some implementations, the images may be geo-referenced images.

In one implementation, the first characteristic is deciduous trees without leaves, and the second characteristic, that includes features beyond that provided with the set of first images having the first characteristic, is deciduous trees with leaves.

In one implementation, the first characteristic may be vegetation having a first volume at a first time, and the second characteristic, that includes features beyond or less than that provided with the set of first images having the first characteristic, may be the vegetation having a second volume (such as an increase in volume that would be caused by growth over one or more seasons, or a decrease in volume that would be caused by damage such as by fire or storms, for example).

In one implementation, the first characteristic may be unpaved areas, and the second characteristic, that includes features beyond or less than that provided with the set of first images having the first characteristic, may be paved areas.

In one exemplary implementation, an exemplary computer system may comprise one or more computer processors and one or more non-transitory computer readable medium storing computer executable code that when executed by the one or more computer processors causes the one or more computer processors to: receive one or more first digital images depicting one or more objects in a first geographic area, the one or more objects lacking one or more features, the one or more first digital images having pixels, the one or more first digital images comprising one or more of: an ortho image depicting a nadir field of view of the one or more objects and an oblique image depicting an oblique field of view of the one or more objects; and train machine learning algorithms to construct, from the one or more first digital images, a first Digital Surface Model of the one or more objects, in which the one or more objects have the one or more features, by comparing the first Digital Surface Model to a predetermined second Digital Surface Model of the one or more objects created using stereo pairs of images, wherein the one or more objects in the predetermined second Digital Surface Model have the one or more features. In some implementations, the images may be geo-referenced images.

In some implementations, the one or more non-transitory computer readable medium storing computer executable code that when executed by the one or more computer processors causes the one or more computer processors to receive a second digital image depicting one or more objects in a second geographic area, the second digital image having pixels, the second geographic area sharing one or more characteristics with the first geographic area; and create a third Digital Surface Model of the one or more objects depicted in the second digital image using the trained machine learning algorithms.

In some implementations, the one or more objects depicted in the one or more first digital images comprise leafless trees, the one or more features are leaves, and the predetermined second Digital Surface Model may be created utilizing at least one of two or more third digital images having pixels, the two or more third digital images comprising one or more stereo-pairs, and LiDAR points, the third digital images and/or LiDAR points depicting trees having leaves, such that the predetermined second Digital Surface Model comprises data indicative of trees with leaves.

In one implementation, the one or more objects depicted in the one or more first digital images comprise vegetation having a first volume at a first time, and the third Digital Surface Model includes the vegetation having a second volume (such as an increase in volume that would be caused by growth over one or more seasons, or a decrease in volume that would be caused by damage such as by fire or storms, for example).

In one implementation, the one or more objects depicted in the one or more first digital images comprise unpaved first areas, and the third Digital Surface Model includes paved first areas, where the first areas are the same physical locations.

In some implementations, the objects in the second geographic area may further comprise a building having a roof, and the computer executable code that when executed by the one or more computer processors further causes the one or more computer processors to: determine solar access values for the roof based on the third Digital Surface Model, and calculate a ray between a sun position and the roof as affected by the third Digital Surface Model in relation to a path of the ray.

In one implementation, a system for creating digital surface models may comprise one or more non-transitory computer readable medium storing computer executable code that when executed by one or more computer processors causes the one or more computer processors to create a digital surface model of a desired geographic area from one or more desired digital images depicting the desired geographic area, the digital surface model depicting objects having a first characteristic including features beyond that depicted in the one or more desired digital images, by utilizing trained machine learning algorithms, the trained machine algorithms having been trained by:
a. generating, with one or more original machine learning algorithms, a candidate Digital Surface Model of a portion of a first geographic area with one or more first images from a set of first images, the candidate Digital Surface Model having a plurality of voxels with at least some of the voxels identifying a location within the first geographic area and having an elevation value, the set of first images depicting at least a portion of the first geographic area with the first characteristic;
b. determining error for the voxels of the candidate Digital Surface Model by comparing elevation values for voxels of the candidate Digital Surface Model to corresponding elevation values for voxels of a predetermined Digital Surface Model of the first geographic area, the predetermined Digital Surface Model created with a set of second images of the first geographic area having a second characteristic including features beyond that provided with the set of first geo-referenced images having the first characteristic;
c. adjusting, via back-propagation, the one or more machine learning algorithms based on the determined error for the voxel of the candidate Digital Surface Model; and
d. repeating a. b. and c. until the determined errors for the voxels is below a predetermined threshold indicating trained machine learned algorithms.

In some implementations, the images may be geo-referenced images.

In one implementation, a system for creating digital surface models may comprise one or more non-transitory computer readable medium storing computer executable code that when executed by one or more computer processors causes the one or more computer processors to: create a digital surface model of a desired geographic area from one or more desired digital images depicting the desired geographic area, the one or more desired digital images not required to be part of stereo image pairs, the Digital Surface Model depicting objects having a first feature beyond that depicted in the one or more desired digital images, by utilizing trained machine learning algorithms, the trained machine algorithms having been trained by iteratively performing, until a predetermined error level is achieved:
receiving one or more first digital images depicting one or more of the objects in a first geographic area separate from the desired geographic area, the objects lacking the first feature;
generating, utilizing initial machine learning algorithms, a first Digital Surface Model from the one or more first digital images; and
determining error of the first Digital Surface Model by comparing, utilizing the initial machine learning algorithms, elevations of voxels in the first Digital Surface Model to elevations of voxels in a predetermined second Digital Surface Model of the objects, the predetermined second Digital Surface Model created using one or more of LiDAR data points and stereo image pairs depicting the objects having the first feature; and adjusting, via back-propagation, the initial machine learning algorithms based on determined error from the comparison, the determined error indicative of the first feature. In some implementations, the images may be geo-referenced images.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more and the singular also includes the plural unless it is obvious that it is meant otherwise.

Further, use of the term “plurality” is meant to convey “more than one” unless expressly stated to the contrary.

As used herein, qualifiers like “substantially,” “about,” “approximately,” and combinations and variations thereof, are intended to include not only the exact amount or value that they qualify, but also some slight deviations therefrom, which may be due to manufacturing tolerances, measurement error, wear and tear, stresses exerted on various parts, and combinations thereof, for example.

The use of the term “at least one” or “one or more” will be understood to include one as well as any quantity more than one. In addition, the use of the phrase “at least one of X, V, and Z” will be understood to include X alone, V alone, and Z alone, as well as any combination of X, V, and Z.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

As used herein any reference to “an implementation,” “one implementation,” “one embodiment,” or “an embodiment” means that a particular element, feature, structure, or characteristic described in connection with the implementation or embodiment is included in at least one implementation or embodiment. The appearances of the phrase “in one implementation” or “in one embodiment” in various places in the specification are not necessarily all referring to the same implementation or embodiment.

Even though particular combinations of features are recited in the claims and/or disclosed in the specification, these combinations are not intended to limit the disclosure. In fact, many of these features may be combined in ways not specifically recited in the claims and/or disclosed in the specification. Further, the phrase “based on” is intended to mean “based, at least in part, on” unless explicitly stated otherwise.

As used herein, the term “stereo pair” refers to two or more images having overlapping pixels captured from the same directional perspective, but from one or more cameras spaced a distance apart, or from one camera at different positions. Stereo pairs may be used to produce a three-dimensional image when viewed together. A stereo-pair may be two photographs depicting at least some of the same area captured by one or more camera from different angles, where the difference in angles is thirty degrees or less, for example. In some implementations, a stereo-pair may be two photographs captured from a same directional perspective, but from different positions or angles, and overlapping with each other 50% or more, for example. In some implementations, a stereo-pair may be two photographs captured from a same directional perspective, but from different positions or angles, and overlapping with each other by at least 60%, for example. A person having skill in the art will understand that the amount of overlap of the two photographs in a stereo-pair may differ. The term “directional perspective” refers to the geographic direction of the field of view of the cameras. For example, a field of view from a northern directional perspective may be a field of view from a camera positioned to the north of an object in the field of view.

The term “overlap” as used herein with regard to images, may indicate, for example, a shared portion of an overall geographic area that is depicted in pixels of two or more images. For example, a first image may be captured from a sensor, such as a camera, having a first field of view of a first geographic region and a second image may be captured from the sensor, such as a camera (or another sensor), having a second field of view of a second geographic region, where the first geographic region and the second geographic region have a shared portion of the overall geographic region. In some implementations, the overlap may be defined as at least some of the pixels of the first image and the second image depicting the same geographic region and/or the same objects in the geographic region.

The term “voxel” as used herein refers to the representation of a point in three-dimensional space. A voxel may be considered an element of volume in an array of elements of volume that constitute a notional three-dimensional space. In some implementations, a voxel may be considered a node of a three-dimensional space region limited by given sizes, which has its own nodal point coordinates in an accepted coordinate system, its own form, its own state parameter that indicates its belonging to some modeled object, and/or properties of the modeled region.

As used herein, the term “Digital Surface Model” (or DSM) refers to a computer-based three-dimensional representation of points of surfaces of a geographic area including elevation data, typically including objects in that geographic area. Surfaces of a geographic area may include ground and any object on the ground (for example, vegetation or structures). In some implementations, a Digital Surface Model may be in the form of a three-dimensional raster file and/or a three-dimensional vector file. In some implementations, a Digital Surface Model may be an elevation model of points having X, Y coordinates (such as latitude and longitude) in a geographic area. Digital Surface Models may comprise continuous data representative of elevation of surfaces, in contrast to a point cloud, which is a discrete data set that gives surface information at all directions. In some implementations, the Digital Surface Model may give (and/or originally give) elevation data from a nadir view perspective, in which the model may originally consider all surfaces representative of the ground (“ground-level”) to have zero-elevation values, where ground includes terrain but not objects on the ground.

The term “Digital Elevation Model” refers to three-dimensional points, including elevation of the terrain from sea-level to ground-level, representing terrain in a geographic area, where terrain includes ground and water, but not objects on the ground or objects on the water.

The term “geo-referenced image” as used herein refers to an image that is associated with geolocation data for at least one pixel in the image. For example, the geolocation data may include X, Y coordinates, such as latitude and longitude. In some implementations, a plurality of the pixels in the geo-referenced image (e.g., in a grid format) may be associated with corresponding geolocation data such that real-world three-dimensional locations of each of the pixels in the image may be calculated using suitable techniques, such as interpolation.

An overhead viewpoint, also referred to as an ortho view or nadir view, typically captures a view taken directly in line with an image sensor, such as a camera lens. This may be directly below and/or vertically downward from an image sensor positioned above an area or object. In some implementations, an ortho or nadir view may be directly in line with an image sensor positioned to the side of an area or object. An oblique perspective is typically within a range from 10 degrees to 75 degrees from a nadir perspective. In some implementations, an oblique perspective may be within a range from 30 degrees to 60 degrees from the nadir perspective, for example. In some implementations, an oblique perspective may be within a range from 40 degrees to 50 degrees from the nadir perspective, for example.

Circuitry, as used herein, may be analog and/or digital components, or one or more suitably programmed processors (e.g., microprocessors) and associated hardware and software, or hardwired logic. Also, “components” may perform one or more functions. The term “component,” may include hardware, such as a processor (e.g., microprocessor), an application specific integrated circuit (ASIC), field programmable gate array (FPGA), a combination of hardware and software, and/or the like. The term “processor” as used herein means a single processor or multiple processors working independently or together to collectively perform a task.

Software includes one or more computer readable instructions, also referred to as executable code, that when executed by one or more components cause the component to perform a specified function. It should be understood that the algorithms described herein may be stored on one or more non-transitory computer readable media.

Exemplary non-transitory computer readable media may include random access memory, read only memory, flash memory, and/or the like. Such non-transitory computer readable media may be electrically based, magnetically based, non-transitory optically based, and/or the like. Non-transitory computer readable medium may be referred to herein as non-transitory memory.

Digital images can be described as pixelated arrays of electronic signals. The array may include two dimensions. Such an array may include spatial (x, y or latitude, longitude) and/or spectral (e.g., red, green, blue) elements. Each pixel in the image captures wavelengths of light incident on the pixel, limited by the spectral bandpass of the system. The wavelengths of light are converted into digital signals readable by a computer as float or integer values. How much signal exists per pixel depends, for example, on the lighting conditions (light reflection or scattering), what is being imaged, and even the chemical properties of the imaged object(s).

Machine learning is a type or subset of Artificial Intelligence (AI). Machine learning, in general, is the scientific study of algorithms and statistical models that computer systems use in order to perform a specific task effectively without using explicit instructions, relying on patterns and inference instead. Machine learning algorithms build a mathematical model based on sample data, known as “training data”, in order to make predictions or decisions without being explicitly programmed to perform the task. Machine learning algorithms may be used in applications, such as digital imagery analysis, where it is infeasible to develop an algorithm of specific instructions for performing one or more task.

Machine learning algorithms may be in the form of an artificial neural network (ANN), also called a neural network (NN). A neural network “learns” to perform tasks by considering examples, generally without being programmed with any task-specific rules. The examples used to teach a neural network may be in the form of truth pairings comprising a test input object and a truth value that represents the true result from the test input object analysis. When a neural network has multiple layers between the input and the output layers, it may be referred to as a deep neural network (DNN). The utilization of neural networks in machine learning is known as deep learning.

For some implementations of machine learning with digital imagery, a computer system may be trained to deconstruct digital images into clusters of aggregated pixels and statistically identify correlations in the clusters. The correlations are iteratively evaluated and “learned” from by the computer system, based on a directive to classify a set of patterns as a specific thing. For example, the directive could be to classify the set of patterns to distinguish between a cat and dog, identify all the cars, find the damage on the roof of a building, and so on.

Over many imaged objects, regardless of color, orientation, or size of the object in the digital image, these specific patterns for the object are mostly consistent—in effect they describe the fundamental structure of the object of interest. For an example in which the object is a cat, the computer system comes to recognize a cat in an image because the system understands the variation in species, color, size, and orientation of cats after seeing many images or instances of cats. The learned statistical correlations may then be applied to new data to extract the relevant objects of interest or information.

Convolutional neural networks (CNN) are machine learning models that may be used to perform this function through the interconnection of equations that aggregate the pixel digital numbers using specific combinations of connections of the equations and clustering the pixels, in order to statistically identify objects (or “classes”) in a digital image.

When using computer-based supervised deep learning techniques, such as with a CNN, for digital images, a user provides a series of examples of digital images of the objects of interest to the computer and the computer system uses a network of equations to “learn” significant correlations for the object of interest via statistical iterations of pixel clustering, filtering, and convolving. For example, the object of interest may be one or more surfaces of a geographic area depicted in the digital images.

The artificial intelligence/neural network output is typically a binary output, formatted and dictated by the language/format of the network used, that may then be implemented in a separate workflow and applied for predictive classification to the broader area of interest. The relationships between the layers of the neural network, such as that described in the binary output, may be referred to as the neural network model or the machine learning model.

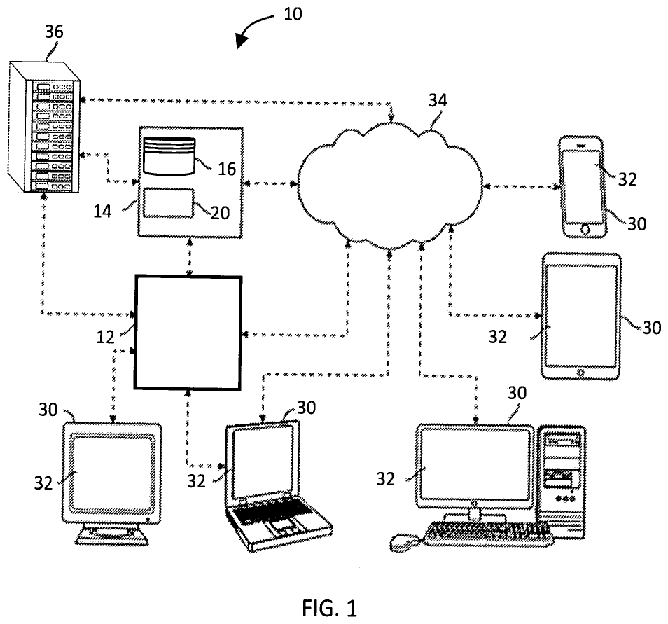

Referring now to the drawings, and in particular to FIG. 1, a system 10 for creating digital surface models may comprise one or more processors 12 (referred to generally as processors 12 and individually as processor 12), and one or more non-transitory memories 14 (referred to generally as memories 14 and individually as memory 14). The one or more non-transitory memories 14 may store one or more databases 16. The one or more non-transitory memories 14 may store computer executable code 20, for example, a set of instructions capable of being executed by the one or more computer processors 12, that when executed by the one or more computer processors 12 causes the one or more computer processors 12 to carry out the methods described. The computer processor 12 or multiple computer processors 12 may or may not necessarily be located in a single physical location. The computer executable code 20 may be stored and executed from one or more than one of the non-transitory memories 14 by one or more than one of the computer processors 12, which may be located in one location or in more than one location.

The system 10 may bi-directionally communicate with a plurality of user devices 30 (which may have display screens 32) and/or may communicate via a network 34. In one embodiment, the network 34 is the Internet and the user devices 30 interface with the system via the communication component and a series of web pages. It should be noted, however, that the network 34 may be almost any type of network and may be implemented as the World Wide Web (or Internet), a local area network (LAN), a wide area network (WAN), a metropolitan network, a wireless network, a cellular network, a Global System for Mobile Communications (GSM) network, a code division multiple access (CDMA) network, a 3G network, a 4G network, a 5G network, a satellite network, a radio network, an optical network, a cable network, an Ethernet network, combinations thereof, and/or the like. It is conceivable that in the near future, embodiments of the present disclosure may use more advanced networking topologies.

In one embodiment, the system 10 comprises a server system 36 having multiple servers in a configuration suitable to provide a commercial computer-based business system such as a commercial web-site and/or data center. In some implementations, the server system 36 may be combined with the one or more computer processors 12 and/or the one or more non-transitory memories 14.

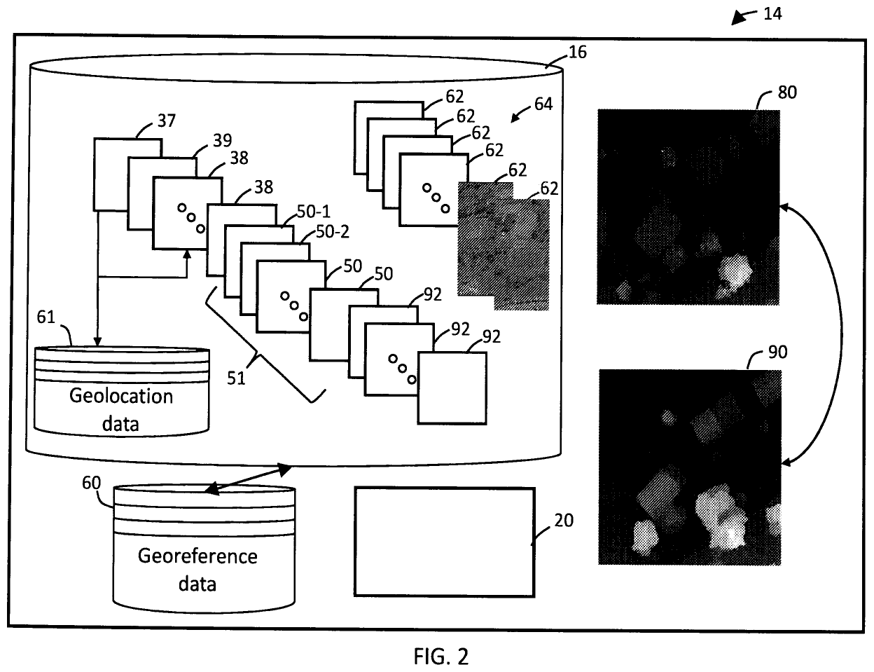

As shown in FIG. 2, the system 10 may include (or capture, create, or receive) a plurality of images 37. The images 37 may include geo-referenced images 38 and/or may include non-georeferenced images 39. In some implementations, the images 37 may be processed to become geo-referenced images 38 using metadata information and/or other coordinate information (such as latitude/longitude). In some implementations, the system 10 may include geolocation data 61 for the images 37 and the images 37 may be associated with the geolocation data 61 to produce the geo-referenced images 38.

In some implementations, the geo-referenced images 38 may have one or more pixels associated with corresponding geolocation data 61. In some implementations, one or more of pixels in the geo-referenced image 38 may be associated with corresponding geolocation data 61, and real-world three-dimensional locations of additional ones of the pixels in the geo-referenced image 38 may be calculated using suitable techniques, such as using interpolation and/or based on image resolution. In one implementation, one or more pixels in the center of the geo-referenced image 38 and/or in one or more corners and/or edges of the geo-referenced image 38 may be associated with corresponding geolocation data 61 and real-world three-dimensional locations of additional ones of the pixels in the geo-referenced image 38 may be calculated or determined.

In some implementations, the geo-referenced images 38 may be represented by pixelated numeric arrays including two dimensions. The two dimensions may be indicative of X, Y coordinates, such as latitude and longitude, or other dimensions.

In some implementations, exemplary ones of the images 37 may be 512×512 pixels per image (that is, 262144 pixels per image). In one implementation, the range of each pixel may vary from 0 to 255.

The images 37 are not required to be a stereo pair of images or be part of a stereo pair of images. The images 37 may be stored in the one or more non-transitory memory 14. The images 37 may be stored in the one or more databases 16, which may be stored in the one or more non-transitory memory 14.

Image data may be associated with one or more of the images 37 and may contain nominal “visible-band” (red, green, blue) wavelength spectral data or other spectral bands data (for example, infrared wavelength spectral data).

In some implementations, the system 10 may include one or more first images 50 in a set 51 of first images 50 of the one or more images 37. The first images 50 may depict at least a portion of a geographic area with a first characteristic. The first images 50 may depict at least a portion of a geographic area missing a first characteristic. The first images 50 may be considered training images. The first images 50 may be or may include the geo-referenced images 38 or the non-georeferenced images 39.

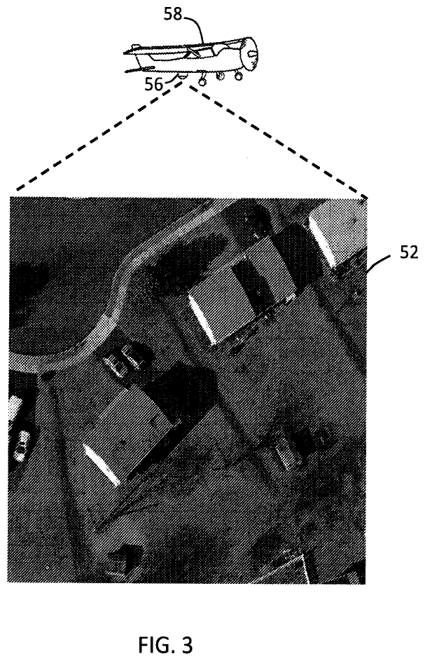

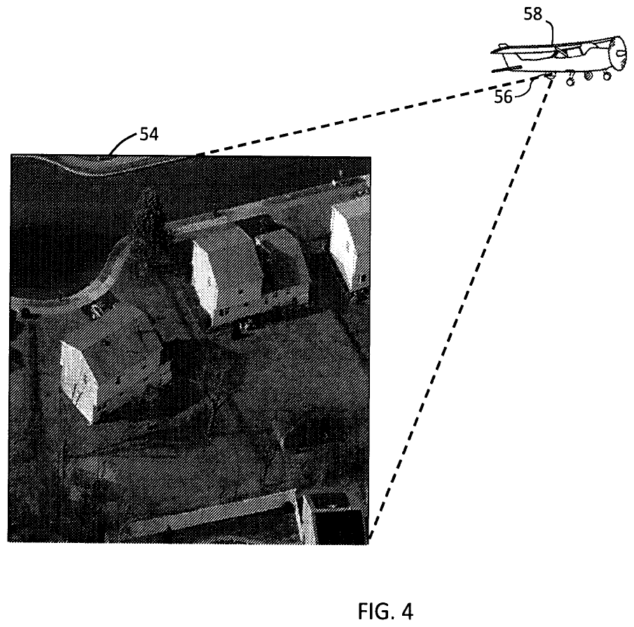

In some implementations, as shown in FIG. 3, for example, the images 37 may include nadir images 52 captured by one or more image sensors 56 from an orthogonal (also known as nadir) viewpoint. In some implementations, as shown in FIG. 4, for example, the images 37 may include oblique images 54 captured by the one or more image sensors 56 from a non-orthogonal (also known as oblique) viewpoint. In some implementations, the images 37 may include oblique images 54 captured by the one or more sensors 56 from an oblique viewpoint and may include nadir images 52 captured by the one or more sensors 56 from a nadir viewpoint. In some implementations, the images 37 may be captured by the one or more sensors 56 on one or more capture platforms 58. In some implementations, the images 37 may be aerial images, ground-based images, or a combination of aerial images and ground-based images. The one or more image sensors 56 may be, or include, one or more cameras. For explanatory purposes, the term camera may be used interchangeably with image sensor 56. The images 37 may be captured independently at different instances of time by the one or more camera 56, and/or at least some of the images 37 may be captured simultaneously using multiple cameras 56.

In one implementation, the capture platform 58 comprises a manned aircraft and/or an unmanned aircraft. The capture platform 58 is shown as an aircraft in the figures for exemplary purposes. In some implementations, the capture platform 58 may comprise one or more vehicle, either manned or unmanned, aerial based or ground based. Exemplary vehicles include an aircraft, an airplane, a helicopter, a drone, a car, a boat, or a satellite. In some embodiments, the one or more cameras 56 may be carried by a person. For example, the camera 56 may be implemented as a portable telephone and/or a portable computer system (such as a computer tablet). In one implementation, the one or more cameras 56 can be oriented and located in various orientations and locations, such as street view, satellite, automotive based, unmanned aerial vehicle based, and/or manned aerial vehicle based.

In some implementations, the images 37 may be captured through the use of a global shutter in which all of the sensors within the camera 56 are exposed simultaneously, a rolling shutter in which different scanlines in the sensor are exposed at different times, or combinations thereof. In one embodiment, one or more of the first images 50 can be a synthetic global shutter image created from a rolling shutter image, or combinations thereof. An exemplary synthetic global shutter image is disclosed in the patent application identified by U.S. patent application Ser. No. 16/343,610 (Pub. No. US2020/0059601A1), entitled “An Image Synthesis System”, which is a national stage filing of PCT/AU2017/051143, both of which are hereby incorporated in their entirety herein.

The geo-referenced images 38 have or are correlated with georeference data 60 (FIG. 2), which is geographic location data indicating the location, orientation, and camera parameters of a camera at the precise moment each of the geo-referenced images 38 is captured. The georeference data 60 can be stored as metadata. Exemplary metadata includes X, Y and Z information (e.g., latitude, longitude and altitude; or other geographic grid coordinates); time; orientation such as pitch, roll, and yaw; camera parameters such as focal length and sensor size; and correction factors such as error due to calibrated focal length, sensor size, radial distortion, principal point offset, and alignment. In some implementations, the pose data of the camera is based on an orthogonal view and is ninety degrees.

The geo-referenced images 38 may be processed such that pixels in the geo-referenced images 38 have geolocation data 61 indicative of a determined geo-location, such as X, Y, coordinates and/or latitude, longitude coordinates. The determined geolocation data 61, such as X, Y coordinates and/or latitude, longitude coordinates, may be included within metadata stored with or associated with the geo-referenced images 38. In some implementations, the geo-referenced images 38 may be georeferenced using the techniques described in U.S. Pat. No. 7,424,133, and/or U.S. patent application Ser. No. 16/343,610 (Pub. No. US2020/0059601A1), the entire contents of each of which are hereby incorporated herein by reference. The geolocation data 61 can be stored within the geo-referenced images 38 or stored separately from the geo-referenced images 38 and related to the geo-referenced images 38 using any suitable technique, such as unique identifiers. The geolocation data 61 may be stored in the one or more databases 16 in the one or more non-transitory memories 14, as illustrated in FIG. 2.

In one implementation, each of the images 37 may have a unique image identifier that allows the definitive identification of each of the images 37, such as by use of metadata, or otherwise stored.

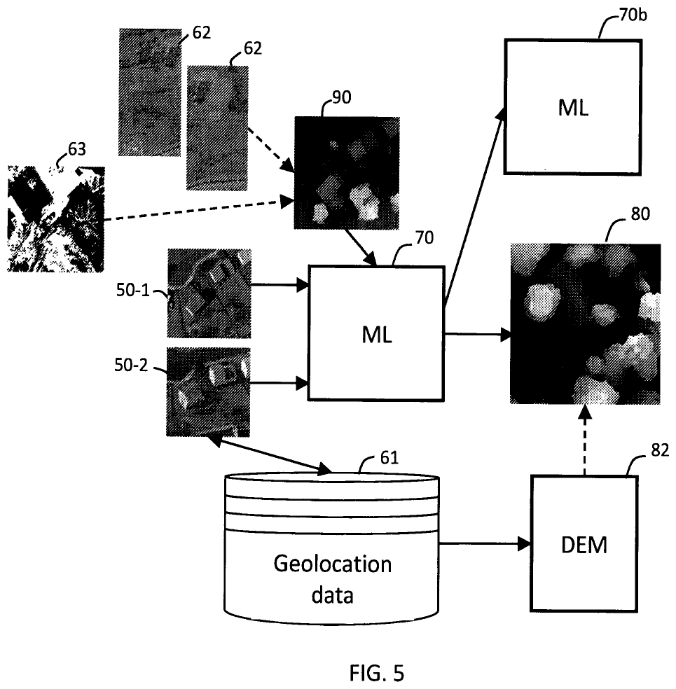

Turning now to FIG. 5, in one implementation, the computer executable code 20 when executed by the one or more computer processors 12 may cause the one or more computer processors 12 to generate, with one or more machine learning algorithms 70, a candidate Digital Surface Model (DSM) 80 of a portion of the first geographic area, utilizing the one or more first images 50 from the set 51 of first images 50. In some implementations, generating the candidate Digital Surface Model 80 utilizes a first one of the first images 50-1 and a second one of the first images 50-2 from the set 51 of the first images 50. In some implementations, the first one of the first images 50-1 and the second one of the first images 50-2 may include one or more nadir image 52 and oblique image 54.

Optionally, the first one of the first images 50-1 and the second one of the first images 50-2 showing a same portion of the first geographic area can be correlated together. For the non-georeferenced images 39, this can be accomplished manually by an operator viewing pairs of the non-georeferenced images 39 showing the same portions and labeling corresponding features within the non-georeferenced images to create one or more tie points within the first one of the first images 50-1 and the second one of the first images images 50-2. For geo-referenced images 38, this correlation can be accomplished either automatically using known algorithms, manually, or a combination of automatically and manually.

The candidate Digital Surface Model 80 may be stored in the one or more non-transitory memory 14, as shown in FIG. 2.

The one or more first images 50 from the set 51 of first images 50 may be training images for the one or more machine learning algorithms 70. The first images 50 may include height information for the ground and for objects depicted in the first images 50, in which the height for the ground is set at zero and the height of the objects is from the ground. Though the term “ground” is used, the concepts described herein apply equally to water and objects on the water. In some implementations, the first images 50 may have voxels and the voxels may be labeled with the height information. In some implementations, each voxel is labeled with height information indicative of the height from ground of the depicted element in the voxel (where objects have non-zero height and ground has zero height).

In some implementations, the one or more first images 50 may be labeled as having a feature or characteristic or not having a feature or characteristic. For example, the one or more first images 50 may be labeled as depicting deciduous trees without leaves and/or the one or more first images 50 may be labeled as depicting deciduous trees with leaves.

The machine learning algorithms 70 may include one or more neural network composed of numerical arrays with nodes and connections. More particularly, in generating the candidate Digital Surface Model 80, the computer executable code 20 when executed may cause the one or more computer processors 12 to pass the numerical arrays representing the one or more first images 50 through the numerical arrays of the neural network. This may include down-sampling and up-sampling, in which the values of the numerical arrays of the first images 50 are multiplied through layers of the numerical arrays of the neural network. The layers may be organized to output the desired results.

The generated candidate Digital Surface Model 80 has a plurality of voxels. In some implementations, the voxels may identify locations having X, Y coordinates within the first geographic area. The voxels may have elevation values (Z coordinates) for the locations, which may be referred to as elevation tiles. The generated candidate Digital Surface Model 80 may contain continuous data of the geographic area. The generated candidate Digital Surface Model 80 may include (and/or initially include) elevation data at a nadir view perspective. In some implementations, an initial elevation value for the voxels may be ground-level based elevations. The initial elevation values for the voxels representing the surfaces of objects depicted in the one or more first images 50 may be ground-level height values, that is, the height of depicted objects from the ground, where the ground may initially be considered to have an elevation of zero.

In some implementations, the first images 50 may be geo-referenced images 38, and generating the candidate Digital Surface Model 80 may also comprise incorporating elevation data for terrain (that is, elevation from sea level) in the first geographic area by utilizing the geolocation data 61 of the geo-referenced images 38 to locate the elevation data in a Digital Elevation Model 82. In some implementations, the elevation values of the voxels of the candidate Digital Surface Model 80 may be adjusted based on elevation values from a Digital Elevation Model 82. The computer executable code 20 when executed may cause the one or more computer processors 12 to locate the elevation data in a Digital Elevation Model 82 based on the X, Y coordinates (e.g., latitude, longitude) of the voxel (which may originate from the geo-referenced image(s) 50), and add elevation from sea-level from the Digital Elevation Model 82 to the elevation tile (that is, to the ground-level elevation) of the candidate Digital Surface Model 80.

In some implementations, generating the candidate Digital Surface Model 80 may comprise incorporating real-world elevation data for terrain (that is, elevation from sea level for particular geographic locations within the first geographic area) in the first geographic area by other methods, such as, but not limited to, utilizing altimeter data, geoid data, orthometric height, contour maps, and/or other sources of terrain elevation data. In some implementations, one or more voxel depicting ground is labeled with elevation information indicative of the height from sea-level of the depicted element in the voxel.

In some implementations, elevation data for the terrain may be determined by correlating one or more of the geo-referenced images 38 with one or more of the non-geo-referenced images 39. In some implementations, elevation data for the terrain may be determined by manually correlating two or more of the first images 50. In some implementations, elevation data for the terrain may be determined and manually added to the first images 50 and/or the candidate Digital Surface Model 80.

Further, in some implementations, elevation data for terrain (that is, elevation from sea level) may not be incorporated, resulting in the candidate Digital Surface Model 80 being based on height from ground level (that is, assuming the terrain has a zero elevation). In such implementations, the images 39 used may not be geo-referenced, as the associated geolocation data 61 is not required.

The computer executable code 20 when executed may cause the one or more computer processors 12 to determine an error for the voxels of the candidate Digital Surface Model 80 by comparing elevation values for the voxels of the candidate Digital Surface Model 80 to elevation values for corresponding voxels of a predetermined Digital Surface Model 90 of the first geographic area.

In some implementations, the computer executable code 20 when executed may cause the one or more computer processors 12 to find corresponding voxels in the candidate Digital Surface Model 80 and the predetermined Digital Surface Model 90, in order to compare the elevations values, by matching X, Y coordinates of the voxels of the candidate Digital Surface Model 80 with X, Y coordinates of the voxels of the predetermined Digital Surface Model 90. For example, a first voxel in the candidate Digital Surface Model 80 may have first X, Y coordinates (such as latitude and longitude), while a second voxel in the predetermined Digital Surface Model 90 may have second X, Y coordinates that are the same as the first X, Y coordinates, so that the first voxel and second voxel are considered to be corresponding voxels. In some implementations, the candidate Digital Surface Model 80 and the predetermined Digital Surface Model 90 are of same resolution, for example, six decimals of latitude, longitude coordinates, and the coordinates are matched to that resolution. In some implementations, the matching of the voxels takes place at every corresponding pixel.

In some implementations, the predetermined Digital Surface Model 90 may be created automatically, without manual intervention, since manual intervention to the predetermined Digital Surface Model 90 may corrupt the ground truth data, which in turn affects the performance of the machine learning algorithms 70 in creating accurate candidate Digital Surface Model 80 (that is, such that the ground truth for the generated candidate Digital Surface Model 80 equals the ground truth of the predetermined Digital Surface Model 90).

The predetermined Digital Surface Model 90 may be, or may have been, created with data representative of the first geographic area having a second characteristic including features beyond that provided with the set 51 of first images 50 having the first characteristic.

The predetermined Digital Surface Model 90 may be, or may have been, created with data representative of the first geographic area having a second characteristic including fewer, less than, or different features beyond that provided with the set 51 of first images 50 having the first characteristic.

In some implementations, the predetermined Digital Surface Model 90 may be, or may have been, created with LiDAR data 63 representative of the first geographic area having a second characteristic including features beyond that provided with the set 51 of first images 50 having the first characteristic. The predetermined Digital Surface Model 90 may be, or may have been, created with a set 64 of second geo-referenced images 62 of the first geographic area having a second characteristic including features beyond that provided with the set 51 of first images 50 having the first characteristic. The set 64 of second geo-referenced images 62 may comprise stereo-image pairs. The predetermined Digital Surface Model 90 may be, or may have been, created from images that are not stereo pairs. The predetermined Digital Surface Model 90 may be, or may have been, created without using machine learning algorithms.

In this way, at least a portion of the determined error for the elevations of the voxels of the candidate Digital Surface Model 80 in comparison to the elevations of the voxels of the predetermined Digital Surface Model 90 may be indicative of the second characteristic. In some implementations, this may be thought of as “introduced error,” which may be utilized to train the machine learning algorithms 70 to add the second characteristic even though the second characteristic is not provided within input images 37.

In one example, the first characteristic may be deciduous trees without leaves, and the second characteristic may be deciduous trees with leaves. In one example, the first characteristic may be one or more objects having an obstruction, and the second characteristic may be the one or more objects without the obstruction.

In one example, the first characteristic may be vegetation having a first volume at a first time, and the second characteristic, that includes features beyond or less than that provided with the set of first images having the first characteristic, may be the vegetation having a second volume (such as an increase in volume that would be caused by growth over one or more seasons, or a decrease in volume that would be caused by damage such as by fire or storms, for example).

In one example, the first characteristic may be unpaved areas, and the second characteristic, that includes features beyond or less than that provided with the set of first images having the first characteristic, may be paved areas.

In one implementation, determining the error for the voxels of the candidate Digital Surface Model 80, by comparing elevation values for the voxels of the candidate Digital Surface Model 80 to elevation values for corresponding voxels of the predetermined Digital Surface Model 90 of the first geographic area, utilizes root mean square error (RMSE), such as by using the following formula:

$$RMSE = \sqrt{\frac{1}{n} {\sum }_{i = 1}^{n} {( {\hat{y}}_{l} - {y}_{i} )}^{2}}$$

where “γ” is the elevation of a voxel from the predetermined Digital Surface Model 90 and “\hat{γ}” is the elevation of a corresponding voxel from the candidate Digital Surface Model.

Further, the computer executable code 20 when executed may cause the one or more computer processors 12 to determine the quality of the candidate Digital Surface Model 80. In one implementation determining the quality of the candidate Digital Surface Model 80 may be by utilizing a Structural Similarity Index Measure (SSIM) or a Peak Signal to Noise Ratio (PSNR). For example, the Peak Signal to Noise Ratio may be calculated with the following formula:

$$PSNR = 10 * {log}_{10} \frac{{MAX}^{2} ( y )}{MSE ( y , \hat{y} )}$$

where MAX represents a maximum of the ground-truth elevations (γ) and MSE is the mean square error of the elevation of the voxels of the predetermined Digital Surface Model 90 compared to the elevation of the corresponding voxels from the candidate Digital Surface Model 80.

The computer executable code 20 when executed may cause the one or more computer processors 12 to adjust, via back-propagation, the one or more machine learning algorithms 70 based on the determined error for the voxel of the candidate Digital Surface Model 80. Back-propagation improves the accuracy of future iterations of the candidate Digital Surface Model 80. Back-propagation may include adjusting the layers of the numerical arrays of the neural network. Adjusting the one or more machine learning algorithms 70 in this way results in trained machine learning algorithms 70b.

Determining error for the voxels of the candidate Digital Surface Model 80 and adjusting, via back-propagation, the one or more machine learning algorithms 70 based on the determined error for the voxel of the candidate Digital Surface Model 80, may be repeated, in a plurality of iterations.

The determined error for the voxel of the candidate Digital Surface Model 80 includes the difference between the first characteristic and the second characteristic as reflected in the candidate Digital Surface Model 80 and the predetermined Digital Surface Model 90, respectively. For example, if the first characteristic is deciduous trees without leaves, and the second characteristic is deciduous trees with leaves, then the candidate Digital Surface Model 80 includes a representation of the surface of the deciduous trees without leaves, while the predetermined Digital Surface Model 90 includes a representation of the surface of the deciduous trees with leaves, and the determined errors for the voxels of the candidate Digital Surface Model 80 would include the difference between the elevation of the surfaces of the deciduous trees without leaves and the deciduous trees with leaves.

In this way, a feature or characteristic that is not included in the inputted first images 50 may be represented in the candidate Digital Surface Model 80. Similarly, a feature or characteristic that is included in the inputted first images 50 may be removed from the candidate Digital Surface Model 80 through the back-propagation process. It will be understood, the characteristic of deciduous trees is simply an example of any feature or characteristic that may be added or removed with the machine learning algorithms 70 using the systems and methods described.

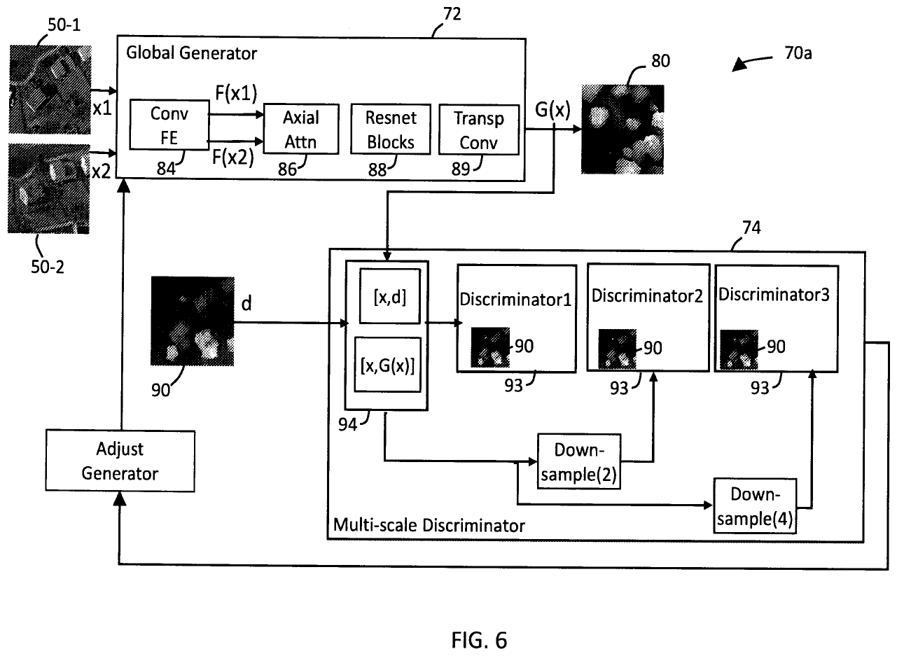

As shown in FIG. 6, in some implementations, the machine learning algorithms 70 may include one or more Generative Adversarial Networks (GAN) 70a configured as discussed below. The Generative Adversarial Network 70a is a neural network deep learning architecture, comprising one or more first neural networks, referred to as a Generator 72, pitted against one or more second neural networks, referred to as a Discriminator 74, creating an adversarial connection. The Generator 72 generates new data instances, while the Discriminator 74 evaluates the new data instances for authenticity. That is, the Discriminator 74 decides whether each data instance belongs to the training data set or not. The Generator 72 learns from the Discriminator 74 to generate an improved candidate Digital Surface Model 80 such that the Discriminator 74 cannot differentiate between the predetermined Digital Surface Model 90 (that was previously determined and known, such as from other methodologies and/or previous iterations) and the newly generated candidate Digital Surface Model 80. The Discriminator 74 challenges the Generator 72 by effectively finding the candidate Digital Surface Model 80 as “fake.”

The Generator 72 may be configured to receive a first input x1 and a second input x2 different that the first input x1, in the form of the first and second ones of the first images 50-1, 50-2. For example, the first input x1 and the second input x2 may be two nadir images 52, or the first input x1 may be a nadir image 52 and the second input x2 may be an oblique image 54. In some implementations, the oblique image 54 may provide an additional perspective that may be used to determine elevation. In some implementations, the Generator 72 may have a convolutional front-end 84, an Axial Attention Network 86, Resnet blocks 88 (also referred to as residual blocks), and transpose convolutions 89.

The convolutional front-end 84 may be a shared-weight model, in which the weights learned are shared between the first and second inputs x1, x2. The Axial Attention Network 86 may transfer attention-based features from output of the convolutional front-end 84 to other components of the Generator 72, such as the Resnet blocks 88, and transpose convolutions 89. The Resnet blocks 88 may contain convolutional layers and normalization to extract features. The transpose convolutions 89 may comprise upsampling technique(s) used to upsample the extracted feature map size in order to meet an actual size of the candidate Digital Surface Model 80. The Generator 72 may output voxels of the candidate Digital Surface Model 80 in the form of a generated image G(x).

The Discriminator 74 may be a multi-scale model, comprising multiple discriminator models 93, which may have different scaled versions of the input. The Discriminator 74 may receive input 94 from the Generator 72, the input may comprise a channel-level concatenation of the first input x1 and ground truth output (G (x) and d). The ground truth output may include information regarding the ground height (d) from the predetermined Digital Surface Model 90 and information regarding the output G(x) from the Generator 72, that is, voxels of the candidate Digital Surface Model 80. In some implementations, for example, in which the first input x1 is a nadir image 52 and the second input x2 is an oblique image 54, the method may feed the nadir image 52 to the Discriminator 74 but not the oblique image 54, since the nadir image 52 has a similar viewpoint to the original input (for example, stereo-pair second images 62 and/or LiDAR data 63) of the predetermined Digital Surface Model 90.

The Discriminator 74 may determine whether the input image x1 is real, that is, whether elevation of the voxels of the candidate Digital Surface Model 80 in the form of a generated image G(x) produced by the Generator 72 match elevation of the voxels of the predetermined Digital Surface Model 90.

The computer executable code 20 when executed may cause the one or more computer processors 12 to iteratively repeat the generation of the candidate Digital Surface Model 80, determining error for the voxels of the candidate Digital Surface Model 80, and the adjustment of the one or more machine learning algorithms 70, 70a based on the determined error for the voxels of the candidate Digital Surface Model 80. Adjustment of the one or more machine learning algorithms 70, 70a, may comprise back-propagation of the one or more machine learning algorithms 70 based on the determined error for the voxel of the candidate Digital Surface Model 80. Back-propagation improves the accuracy of future iterations of the candidate Digital Surface Model 80. Back-propagation may include adjusting the layers of the numerical arrays of the neural network. Adjusting the one or more machine learning algorithms 70, 70a in this way results in trained machine learning algorithms 70b.

This iteration may continue until the determined errors for the voxels of the candidate Digital Surface Model 80 is below a predetermined threshold (that is, above a predetermined accuracy level threshold) indicating that the machine learning algorithms 70, 70a are now trained machine learned algorithms 70b. In one example, the predetermined accuracy level threshold is 80% accuracy. In some implementations, the loss of the Discriminator 74 and the loss of the Generator 72 may be used to define the training performance, that is, to calculate the accuracy. Each iteration may be referred to as an epoch.

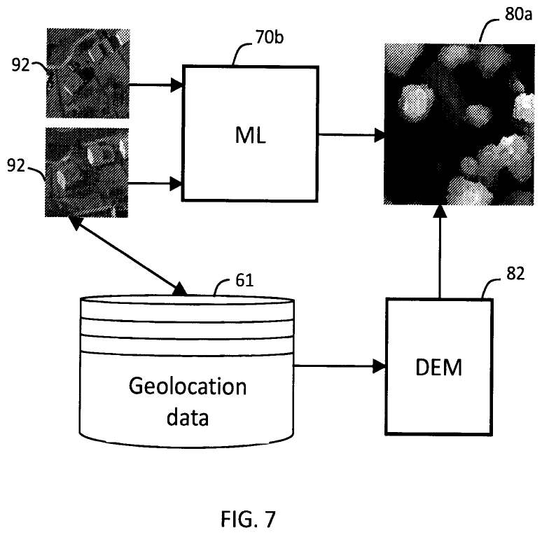

As shown in FIG. 7, the computer executable code 20 when executed may cause the one or more computer processors 12 to generate with the trained machine learning algorithms 70b, a new Digital Surface Model 80a from a set of third images 92 of the geo-reference images 38. The set of third images 92 may be images that are not required to be part of a stereo-pair of images. The set of third images 92 may be geo-referenced images 38.

The set of third images 92 depict a second geographic area. The second geographic area may cover a different geographic region than the first geographic area covers. The first geographic area and the second geographic area may have similar features. For example, the first geographic area and the second geographic area may have similar types of vegetation, terrain, objects, and/or structures. In one implementation, the first geographic area and the second geographic area may have similar types, height, and/or density of trees. In one implementation, the first geographic area and the second geographic area may have buildings having similar roofs, such as type, number of facets, height, and/or orientation of the roofs.

In some implementations, the elevation values of the voxels of the new Digital Surface Model 80a may be adjusted based on elevation values from a Digital Elevation Model 82. The computer executable code 20 when executed may cause the one or more computer processors 12 to locate the elevation data in a Digital Elevation Model 82 based on the X, Y coordinates (e.g., latitude, longitude) of the voxel (which may originate from the geo-referenced image(s) 50), and add elevation from sea-level from the Digital Elevation Model 82 to the elevation tile (that is, to the ground-level elevation) of the new Digital Surface Model 80a.

In some implementations, the third images 92 may be geo-referenced images 38, and generating the new Digital Surface Model 80a may comprise incorporating elevation data for terrain in the first geographic area by utilizing the geolocation data 61 of the geo-referenced images 38 to locate the elevation data in a Digital Elevation Model 82. The Digital Elevation Model 82 may be organized by, or searchable by, geo-location data, such as X, Y coordinates (e.g., latitude, longitude).

In some implementations, generating the new Digital Surface Model 80a may comprise incorporating elevation data for terrain (that is, elevation from sea level) in the first geographic area by other methods, such as, but not limited to, utilizing altimeter data, geoid data, orthometric height, contour maps, and/or other sources of terrain elevation data. In some implementations, one or more voxel depicting ground is labeled with elevation information indicative of the height from sea-level of the depicted element in the voxel.

In some implementations, elevation data for the terrain may be determined by correlating one or more of the geo-referenced images 38 with one or more of the non-geo-referenced images 39. In some implementations, elevation data for the terrain may be determined by manually correlating two or more of the third images 92. In some implementations, elevation data for the terrain may be determined and manually added to the third images 92 and/or the new Digital Surface Model 80a.

Further, in some implementations, elevation data for terrain (that is, height from sea level) may not be incorporated, resulting in the new Digital Surface Model 80a being based on height from ground level (that is, assuming the terrain has a zero elevation). In such implementations, the non-geo-referenced images 39 may be used, as associated geolocation data 61 is not required.

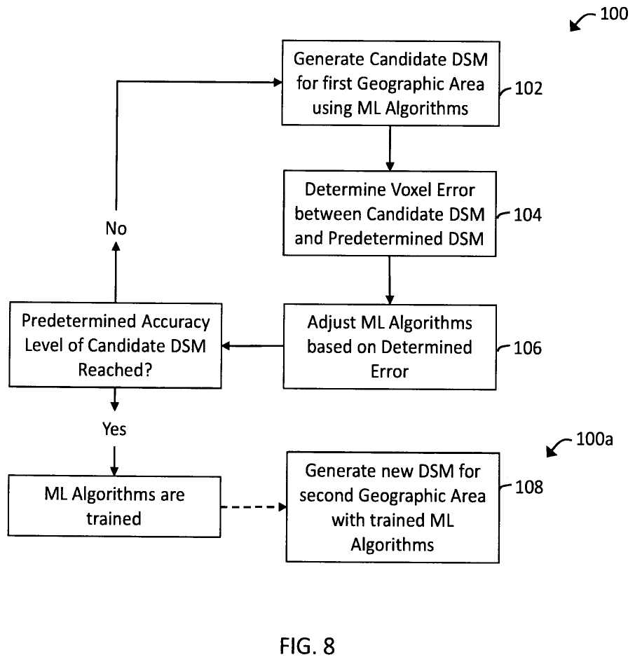

Turning now to FIG. 8, a method 100 for creating digital surface models may comprise generating (in step 102), with the one or more computer processors 12, with the one or more machine learning algorithms 70, 70a, a candidate Digital Surface Model 80 of a portion of a first geographic area with one or more first images 50 from a set 51 of first images 50, the candidate Digital Surface Model 80 having a plurality of voxels with at least some of the voxels identifying a location within the first geographic area and having an elevation value, the set 51 of first images 50 depicting at least a portion of the first geographic area with a first characteristic.

The method 100 may further comprise determining (in step 104), with the one or more computer processors 12, an error for the voxels of the candidate Digital Surface Model 80. The error may be determined by comparing elevation values for voxels of the candidate Digital Surface Model 80 to corresponding elevation values for voxels of a predetermined Digital Surface Model 90. The predetermined Digital Surface Model 90 may be of the first geographic area. The predetermined Digital Surface Model 90 may be created with a set of second geo-referenced images 62 of the first geographic area having a second characteristic. In some implementations, the second characteristic includes features beyond that provided with the set of first images 50 having the first characteristic. In some implementations, the second characteristic includes having fewer than, or not having, features provided with the set of first images 50 having the first characteristic. In some implementations, the second characteristic is the same as the first characteristic.

In some implementations, the predetermined Digital Surface Model 90 may be a first predetermined Digital Surface Model 90, and the candidate Digital Surface Model 80 and the predetermined Digital Surface Model 90 may have the same first characteristic, and an error for the voxels of the candidate Digital Surface Model 80 between the trained candidate Digital Surface Model 80 and a second predetermined Digital Surface Model may be determined.

The method 100 may further comprise adjusting (in step 106), via back-propagation, the one or more machine learning algorithms 70 based on the determined error for the voxels of the candidate Digital Surface Model 80.

The method may iteratively repeat steps 102, 104, and 106 until the determined errors for the voxels of the candidate Digital Surface Model 80 is below a predetermined threshold indicating that trained machine learned algorithms 70b have been produced. Each iteration may be referred to as an epoch.

In some implementations, in the first epoch, the candidate Digital Surface Model 80 may be generated with initialized weights of the model. The initialized weights may be random. In some implementations, the method uses 15,000 or more of the first images 50 to train the machine learning algorithms and reach the predetermined threshold for errors.

The method 100 may further comprise generating (in step 108) with the trained machine learning algorithms 70b, a new Digital Surface Model 80a using a set of third images 92 depicting a second geographic area. In some implementations, the third images 92 may be geo-referenced images 38.

In some implementations, a method 100a comprises utilizing the trained machine learning algorithms 70b to generate a new Digital Surface Model 80a using a set of third images 92 depicting a second geographic area utilizing the trained machine learning algorithms 70b.

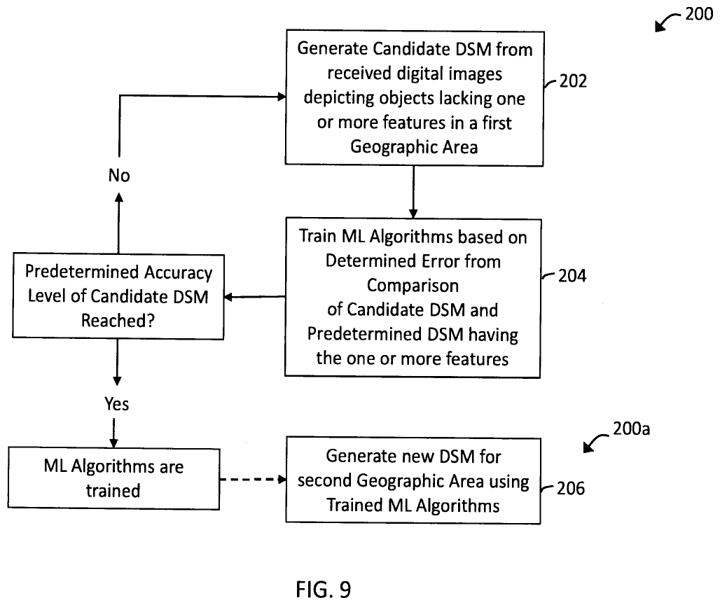

Turning now to FIG. 9, another method 200 for training a system to construct digital surface models may comprise receiving (in step 202), with the one or more computer processors 12, one or more first digital images 50 depicting one or more objects in a first geographic area, the one or more objects lacking one or more features. The one or more first digital images 50 are not required to be a stereo pair of images or be part of stereo pairs. The one or more first digital images 50 may include one or more of: an ortho nadir image 52 depicting a nadir field of view of the one or more objects and/or an oblique image 54 depicting an oblique field of view of the one or more objects in the first geographic area.

The method 200 may comprise training (in step 204), with the one or more computer processors, machine learning algorithms 70 to construct, from the one or more first digital images 50, a candidate Digital Surface Model 80 of the one or more objects, in which the one or more objects have the one or more features, by comparing the candidate Digital Surface Model 80 to a known predetermined Digital Surface Model 90 of the one or more objects. The predetermined Digital Surface Model 90 may have been created (or may be created) using stereo pairs of second images 62 and/or LiDAR data 63 of the first geographic area, wherein the one or more objects in the known predetermined Digital Surface Model 90 have the one or more features.

The one or more first digital images 50 may be georeferenced digital images 38, such that the pixels are associated with corresponding geolocation information 61 (such as latitude and longitude).

The one or more first digital images 50 may include an oblique image 54 having an oblique field of view from a northern, eastern, western, southern, or other directional perspective. In some implementations, the one or more first digital images 50 may include an oblique image 54 having an oblique field of view from a northern perspective. In some implementations, the correlation of visual features in a nadir image 52 with visual features in an oblique image 54 having an oblique field of view from a northern perspective results in a more accurate correlation than the correlation of visual features between first digital images 50 having other directional perspectives.

The machine learning algorithms 70 may comprise Generative Adversarial Networks (GANs), such as the modified Generative Adversarial Network 70a.

The step 202 and the step 204 of receiving and training may be iteratively performed by the one or more computer processors 12. The steps of receiving and training may be iteratively performed by the one or more computer processors 12 until a confidence rating indicative of a level of confidence that the candidate Digital Surface Model 80 is accurate exceeds a predetermined level of confidence based on calculated error of the elevation of voxels in the candidate Digital Surface Model 80 in comparison to elevation of voxels in the predetermined Digital Surface Model 90. In one implementation, the predetermined level of confidence is 80%. Once the error level is below a predetermined level (such that the level of confidence exceeds a predetermined level of confidence), then the machine learning algorithms 70 may be considered trained machine learning algorithms 70b.

The method 200 may comprise receiving and/or obtaining with the one or more computer processors 12, one or more third digital images 92 depicting one or more objects in a second geographic area, the second geographic area sharing one or more characteristics with the first geographic area. The method 200 may comprise generating (in step 206), with the one or more computer processors 12, a new Digital Surface Model 80a of the one or more objects depicted in the one or more third digital images 92 using the trained machine learning algorithms 70b.

In some implementations, a method 200a comprises generating (in step 206) a new Digital Surface Model 80a using a set of third images 92 depicting a second geographic area utilizing the trained machine learning algorithms 70b. In some implementations, the third images 92 may be geo-referenced images 38.

In one implementation, the one or more objects depicted in the one or more first digital images 50 comprise leafless deciduous trees, the one or more features are leaves, and the known predetermined second Digital Surface Model 90 is based on an analysis of two or more second digital images 62 having pixels. The two or more second digital images 62 may comprise one or more stereo-pairs. The two or more second digital images 62 may depict deciduous trees having leaves, such that the predetermined second Digital Surface Model 90 comprises data indicative of deciduous trees with leaves.

In one implementation, the objects in the second geographic area may comprise a building having a roof. The method 200 may include determining, with the one or more computer processors 12, solar access values for the roof based on the new Digital Surface Model 80a, and calculating a ray between a sun position and the roof as affected by the new Digital Surface Model 80a in relation to a path of the ray. In some implementations, determining solar access values for the roof based on the new Digital Surface Model 80a may utilize, for example, methods and systems described in U.S. Patent Publication Number US 2020/0098170 A1, “Method and System for Determining Solar Access of a Structure,” the entire contents of which are hereby incorporated herein.

A non-exclusive example of the methods 100, 200 in use for constructing a Digital Surface Model 80a will now be described. The first digital images 50 may be received or obtained by the computer processor 12 and may depict a first geographic area including one or more houses having a roof and one or more deciduous trees without leaf canopies. The first digital images 50 may include one or more nadir images 52 and one or more oblique images 54. In some implementations, one or more of the oblique images 54 may be captured from a northern perspective (that is, from a viewpoint originating from a northern direction).

The machine learning algorithms 70, 70a may be utilized to generate the candidate Digital Surface Model 80 utilizing the one or more first digital images 50. In some implementations, two of the first digital images 50 depicting the first geographic area may be used as inputs into the Generator 72 of the GAN 70a, which may generate the candidate Digital Surface Model 80. A nadir image 52 and an oblique image 45 may be used as the inputs. The Discriminator 74 of the GAN 70a may determine error in the voxels in the candidate Digital Surface Model 80 by comparing the elevation of one or more voxels in the candidate Digital Surface Model 80 against the elevation of corresponding ones of voxels in the predetermined Digital Surface Model 90.

The predetermined Digital Surface Model 90 may be based on stereo-pair second images 62 that depict the first geographic area, but in which the deciduous trees are depicted with leaf canopies.

The determined error in the voxels in the candidate Digital Surface Model 80 includes the differences in the elevation of the voxels depicting the deciduous trees without leaf canopies versus the voxels depicting the deciduous trees with leaf canopies.

The determined error may then be used to adjust or to “train” the machine learning algorithms 70 (such as the Generator 72), such that the machine learning algorithms 70/Generator 72 will add the elevation to account for leaf canopies, even though the leaf canopies are not depicted in the input images 50. In one implementation, back-propagation may be used to adjust the machine learning algorithms.

The generation of the candidate Digital Surface Model 80, the comparison and determination of voxel error of the candidate Digital Surface Model 80, and the adjustment to the machine learning algorithms 70, may be repeated iteratively until a predetermined level of accuracy (or confidence level) is reached. At that point, the machine learning algorithms 70 may be considered to be trained machine learning algorithms 70b.

Then, one or more third digital images 92 that depict a second geographic area may be used as inputs into the trained machine learning algorithms 70b. The second geographic area may be similar to the first geographic area, in that the first and second geographic areas may share types of features or characteristics, such as the same types of trees, tree height, tree maturity, etc. Additionally, the third digital images 92 that depict a second geographic area may be images that were captured when the trees were without leaf canopies. The trained machine learning algorithms 70b (such as the trained Generator 72) then generate a new Digital Surface Model 80a of the second geographic area, in which elevation has been added to voxels representing trees in order to account for leaf canopies for the trees.

Data regarding sea-level elevation of the terrain from a Digital Elevation Model 82 may be added to the ground-level elevation values of the new Digital Surface Model 80a.

### Experimental Results of Hypothetical Testing

Testing was performed with thirty property addresses where each address had nine image tiles depicting the geographic area of the property address, and the mean of the obtained metrics are shown below:

### Testing Samples: 270

Root Mean Square Error (RMSE): 7.272
Peak Signal to Noise Ratio (PSNR): 8.687
Structural Similarity Index Measure (SSIM): 63.401

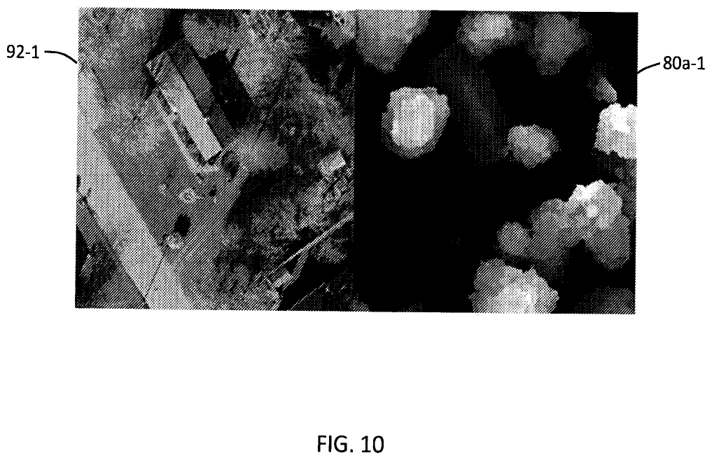

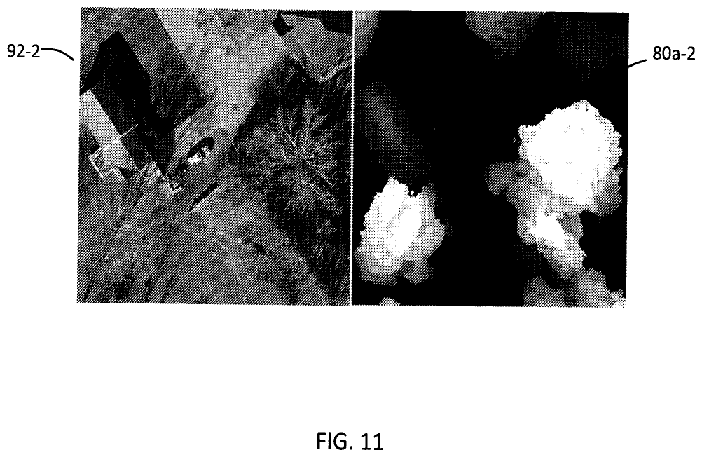

FIGS. 10 and 11 show a first and a second generated new Digital Surface Models 80a-1, 80a-2 based on trained machine learning algorithms 70b that were trained using the modified GAN 70a in the methods 100, 200 as described, and using the input of a first and second georeferenced third images 92-1, 92-2, respectively (without requiring stereo-pairs of images). The new Digital Surface Models 80a-1, 80a-2 are comparatively smooth as they do not contain no-data values.

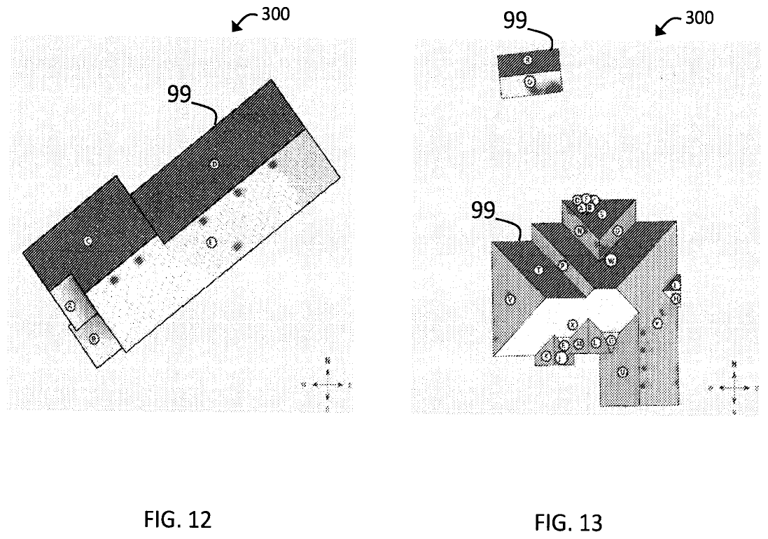

Examples of the methods 100, 200 in use include determination of solar access, in which the new Digital Surface Model 80a serves as a shade scene and/or structure models to calculate solar access values used to determine estimated electricity production and/or guide the design of solar module locations. FIGS. 12 and 13 illustrate irradiance maps 300 of structures 99 that were constructed based on the new Digital Surface Model 80a and solar data. In this example, the irradiance maps 300 are indicative of amounts of solar access of facets of the roofs of the structures 99, where different colors indicate different amounts of solar access.

### Hypothetical Use Cases

Hypothetical use cases include using the new Digital Surface Model 80a as the basis for the point cloud data and/or the structure models as described in the patent application identified by U.S. Ser. No. 16/579,436 (Pub. No. US 2020/0098170 A1), entitled “Method and System for Determining Solar Access of a Structure,” filed Sep. 23, 2019.

Further hypothetical, non-exclusive, use cases include the following: utilization of the calculated solar access values based on the new Digital Surface Model 80a and solar data as an input to manual J calculations for equipment sizing for HVAC; utilization of the new Digital Surface Model 80a as a shade scene to calculate solar access values used to inform window design for optimal energy efficiency; commercial building management use cases whereas the new Digital Surface Model 80a serves as a shade scene to calculate solar access values across the entire structure used to inform window and/or exterior material design for optimal energy efficiency (green architecture, LEED building certifications, etc.); data reports for use in the construction and/or repair of structures, such as roofs, walls, windows, doors, siding, etc.; modeling of predictive structures; video game graphics generation; geographic training simulations; landscaping; and tree/vegetation services.

An additional hypothetical use case includes determining increases or decreases in the volume of vegetation, in which the first characteristic may be vegetation having a first volume at a first time, and the second characteristic, that includes features beyond or less than that provided with the set of first images 50 having the first characteristic, may be the vegetation having a second volume (such as an increase in volume that would be caused by growth over one or more seasons, or a decrease in volume that would be caused by damage such as by fire or storms, for example).

An additional hypothetical use case includes determining an increase or decrease in flood risks for a geographic area based on paving unpaved portions of the geographic area, in which the first characteristic may be unpaved areas, and the second characteristic, that includes features beyond or less than that provided with the set of first images 50 having the first characteristic, may be paved areas.

### CONCLUSION

Conventionally, either stereo-pairs of images and triangulation techniques (e.g., aerial triangulation) or LiDAR data of objects was required in order to create Digital Surface Models. Further, the models strictly represented the objects depicted in the stereo-pairs or the LiDAR data. In accordance with the present disclosure, Digital Surface Models are constructed utilizing digital images with trained machine learning algorithms that are able to add or subtract features into the Digital Surface Model that are not shown in the digital images.

The foregoing description provides illustration and description, but is not intended to be exhaustive or to limit the inventive concepts to the precise form disclosed. Modifications and variations are possible in light of the above teachings or may be acquired from practice of the methodologies set forth in the present disclosure.

It is to be understood that the steps disclosed herein may be performed simultaneously or in any desired order unless specifically stated otherwise. For example, one or more of the steps disclosed herein may be omitted, one or more steps may be further divided in one or more sub-steps, and two or more steps or sub-steps may be combined in a single step, for example. Further, in some exemplary embodiments, one or more steps may be repeated one or more times, whether such repetition is carried out sequentially or interspersed by other steps or sub-steps. Additionally, one or more other steps or sub-steps may be carried out before, after, or between the steps disclosed herein, for example.

Although each dependent claim listed below may directly depend on only one other claim, the disclosure includes each dependent claim in combination with every other claim in the claim set.

No element, act, or instruction used in the present application should be construed as critical or essential to the invention unless explicitly described as such outside of the preferred embodiment.

The following is a numbered list of non-limiting illustrative implementations of the inventive concept disclosed herein:
1. A method for creating digital surface models, comprising:
   a. generating, with one or more machine learning algorithms, a candidate digital surface model of a portion of a first geographic area with one or more first images from a set of first images, the candidate digital surface model having a plurality of voxels with at least some of the voxels identifying a location within the first geographic area and having an elevation value, the set of first images depicting at least a portion of the first geographic area with a first characteristic;
   b. comparing elevation values for voxels of the candidate Digital Surface Model to corresponding elevation values for voxels of a predetermined Digital Surface Model of the first geographic area to determine an error for the voxels of the candidate Digital Surface Model, the predetermined Digital Surface Model created with a set of second images of the first geographic area having a second characteristic including features beyond that provided with the set of first images having the first characteristic;
   c. adjusting, via back-propagation, the one or more machine learning algorithms based on the determined error for the voxels of the candidate Digital Surface Model; and
   d. repeating a. b. and c. until the determined errors for the voxels is below a predetermined threshold indicating trained machine learned algorithms; and
   e. generating with the trained machine learning algorithms, a new Digital Surface Model using a set of third images depicting a second geographic area.
2. The method for creating digital surface models of implementation 1, wherein the first geographic area covers a different geographic region than the second geographic area.
3. The method for creating digital surface models of implementations 1 or 2, wherein the first geographic area and the second geographic area have similar features.
4. The method for creating digital surface models of any one of implementations 1-3, wherein the first characteristic is deciduous trees without leaves, and the second characteristic including features beyond that provided with the set of first images having the first characteristic is deciduous trees with leaves.
5. The method for creating digital surface models of any one of implementations 1-3, wherein the first characteristic is one or more objects having an obstruction, and the second characteristic including features beyond that provided with the set of first images having the first characteristic is one or more objects without the obstruction.
6. The method for creating digital surface models of any one of implementations 1-5, wherein one or more of the first images, the second images, and the third images are geo-referenced images having one or more pixels having associated geolocation data.
7. The method for creating digital surface models of implementation 6, further comprising: incorporating terrain elevation into one or more of the candidate Digital Surface Model, the predetermined Digital Surface Model, and the new Digital Surface Model.
8. The method for creating digital surface models of implementation 7, wherein incorporating terrain elevation comprises utilizing the geolocation data of the geo-reference images to associate corresponding terrain elevation data with the one or more pixels.
9. A system for creating digital surface models, comprising:
   one or more non-transitory computer readable medium storing computer executable code that when executed by one or more computer processors causes the one or more computer processors to:
   a. generate, with one or more machine learning algorithms, a candidate Digital Surface Model of a portion of a first geographic area with one or more first images from a set of first images, the candidate Digital Surface Model having a plurality of voxels with at least some of the voxels identifying a location within the first geographic area and having an elevation value, the set of first images depicting at least a portion of the first geographic area with a first characteristic;
   b. compare elevation values for voxels of the candidate Digital Surface Model to corresponding elevation values for voxels of a predetermined Digital Surface Model of the first geographic area to determine an error for the voxels of the candidate Digital Surface Model, the predetermined Digital Surface Model created with a set of second images of the first geographic area having a second characteristic including features beyond that provided with the set of first images having the first characteristic;
   c. adjust, via back-propagation, the one or more machine learning algorithms based on the determined error for the voxels of the candidate Digital Surface Model; and
   d. repeat a. b. and c. until the determined errors for the voxels is below a predetermined threshold indicating trained machine learned algorithms; and
   e. generate with the trained machine learning algorithms, a new Digital Surface Model using a set of third images depicting a second geographic area.
10. The system for creating digital surface models of implementation 9, wherein the first geographic area covers a different geographic region than the second geographic area.
11. The system for creating digital surface models of implementations 9 or 10, wherein the first geographic area and the second geographic area have similar features.
12. The system for creating digital surface models of any one of implementations 9-11, wherein the first characteristic is deciduous trees without leaves, and the second characteristic including features beyond that provided with the set of first images having the first characteristic is deciduous trees with leaves.
13. The system for creating digital surface models of any one of implementations 9-11, wherein the first characteristic is one or more objects having an obstruction, and the second characteristic including features beyond that provided with the set of first images having the first characteristic is one or more objects without the obstruction.
14. The system for creating digital surface models of any one of implementations 9-13, wherein one or more of the first images, the second images, and the third images are geo-referenced images having one or more pixels having associated geolocation data.
15. The system for creating digital surface models of any one of implementations 9-14, the one or more non-transitory computer readable medium storing computer executable code that when executed by one or more computer processors causes the one or more computer processors to: incorporate terrain elevation into one or more of the candidate Digital Surface Model, the predetermined Digital Surface Model, and the new Digital Surface Model.
16. The system for creating digital surface models of implementation 15, wherein incorporating terrain elevation comprises utilizing the geolocation data of the geo-reference images to associate corresponding terrain elevation data with the one or more pixels.
17. A method, comprising:
   receiving, with one or more computer processors, one or more first digital images depicting one or more objects in a first geographic area, the one or more objects lacking one or more features, the one or more first digital images having pixels, the one or more first digital images comprising one or more of: an ortho image depicting a nadir field of view of the one or more objects and an oblique image depicting an oblique field of view of the one or more objects; and training, with the one or more computer processors, machine learning algorithms to construct, from the one or more first digital images, a first Digital Surface Model of the one or more objects, in which the one or more objects have the one or more features, by comparing the first Digital Surface Model to a predetermined second Digital Surface Model of the one or more objects created using stereo pairs of images, wherein the one or more objects in the predetermined second Digital Surface Model have the one or more features.
18. The method of implementation 17, wherein the one or more first digital images are not required to be images from stereo pairs of images.
19. The method of implementation 17 or 18, wherein receiving and training are iteratively performed by the one or more computer processors.
20. The method of any one of implementations 17 to 19, further comprising:
   receiving, with the one or more computer processors, a second digital image depicting one or more objects in a second geographic area, the second digital image having pixels, the second geographic area sharing one or more characteristics with the first geographic area; and
   creating, with the one or more computer processors, a third Digital Surface Model of the one or more objects depicted in the second digital image using the trained machine learning algorithms.
21. The method of implementation 20, wherein the one or more objects depicted in the one or more first digital images comprise leafless trees, the one or more features are leaves, and wherein the predetermined second Digital Surface Model is based on an analysis of two or more third digital images having pixels, the two or more third digital images comprising one or more stereo-pairs, the two or more third digital images depicting trees having leaves, such that the predetermined second Digital Surface Model comprises data indicative of trees with leaves.
22. The method of implementation 21, wherein the objects in the second geographic area further comprise a building having a roof, and wherein the method further comprises: determining, with the one or more computer processors, solar access values for the roof based on the third Digital Surface Model, and calculating a ray between a sun position and the roof as affected by the third Digital Surface Model in relation to a path of the ray.
23. The method of any one of implementations 17 to 22, wherein the one or more first digital images are georeferenced digital images, such that one or more of the pixels are associated with corresponding latitude and longitude geolocation information.
24. The method of any one of implementations 17 to 23, wherein the one or more first digital images comprises an oblique image having an oblique field of view from a northern perspective.
25. The method of any one of implementations 17 to 24, wherein the machine learning algorithms comprise Generative Adversarial Networks (GANs).
26. The method of any one of implementations 17 to 25, wherein receiving and training are iteratively performed by the one or more computer processors until a confidence rating indicative of a level of confidence that the first Digital Surface Model is accurate exceeds a predetermined level of confidence.
27. A computer system, comprising:
   one or more computer processors;
   one or more non-transitory computer readable medium storing computer executable code that when executed by the one or more computer processors causes the one or more computer processors to:
   receive one or more first digital images depicting one or more objects in a first geographic area, the one or more objects lacking one or more features, the one or more first digital images having pixels, the one or more first digital images comprising one or more of: an ortho image depicting a nadir field of view of the one or more objects and an oblique image depicting an oblique field of view of the one or more objects; and
   train machine learning algorithms to construct, from the one or more first digital images, a first Digital Surface Model of the one or more objects, in which the one or more objects have the one or more features, by comparing the first Digital Surface Model to a predetermined second Digital Surface Model of the one or more objects created using stereo pairs of images, wherein the one or more objects in the predetermined second Digital Surface Model have the one or more features.
28. The computer system of implementation 27, wherein the one or more first digital images are not required to be images from stereo pairs of images.
29. The computer system of implementation 28, wherein receiving and training are iteratively performed.
30. The computer system of any one of implementations 27 to 29, wherein the computer executable code that when executed by the one or more computer processors further causes the one or more computer processors to:
   receive a second digital image depicting one or more objects in a second geographic area, the second digital image having pixels, the second geographic area sharing one or more characteristics with the first geographic area; and
   create a third Digital Surface Model of the one or more objects depicted in the second digital image using the trained machine learning algorithms.
31. The computer system of implementation 30, wherein the one or more objects depicted in the one or more first digital images comprise leafless trees, the one or more features are leaves, and wherein the predetermined second Digital Surface Model is based on at least one of LiDAR points and two or more third digital images comprising one or more stereo-pairs depicting trees having leaves, such that the predetermined second Digital Surface Model comprises data indicative of trees with leaves.
31. The computer system of implementation 30, wherein the objects in the second geographic area further comprise a building having a roof, and wherein the computer executable code that when executed by the one or more computer processors further causes the one or more computer processors to: determine solar access values for the roof based on the third Digital Surface Model, and calculate a ray between a sun position and the roof as affected by the third Digital Surface Model in relation to a path of the ray.
32. The computer system of any one of implementations 27 to 31, wherein the one or more first digital images are georeferenced digital images, such that the pixels are associated with corresponding latitude and longitude geolocation information.
33. The computer system of any one of implementations 27 to 32, wherein the one or more first digital images comprises an oblique image having an oblique field of view from a northern perspective.
34. The computer system of any one of implementations 27 to 33, wherein the machine learning algorithms comprise Generative Adversarial Networks (GANs).
35. The computer system of any one of implementations 27 to 34, wherein receiving and training are iteratively performed by the one or more computer processors until a confidence rating indicative of a level of confidence that the first Digital Surface Model is accurate exceeds a predetermined level of confidence.
36. A system for creating digital surface models, comprising:
   one or more non-transitory computer readable medium storing computer executable code that when executed by one or more computer processors causes the one or more computer processors to:
   create a digital surface model of a desired geographic area from one or more desired digital images depicting the desired geographic area, the digital surface model depicting objects having a first characteristic including features beyond that depicted in the one or more desired digital images, by utilizing trained machine learning algorithms, the trained machine algorithms having been trained by:
   a. generating, with one or more original machine learning algorithms, a candidate Digital Surface Model of a portion of a first geographic area with one or more first images from a set of first images, the candidate Digital Surface Model having a plurality of voxels with at least some of the voxels identifying a location within the first geographic area and having an elevation value, the set of first images depicting at least a portion of the first geographic area with the first characteristic;
   b. determining error for the voxels of the candidate Digital Surface Model by comparing elevation values for voxels of the candidate Digital Surface Model to corresponding elevation values for voxels of a predetermined Digital Surface Model of the first geographic area, the predetermined Digital Surface Model created with a set of second images of the first geographic area having a second characteristic including features beyond that provided with the set of first images having the first characteristic;
   c. adjusting, via back-propagation, the one or more machine learning algorithms based on the determined error for the voxel of the candidate Digital Surface Model; and
   d. repeating a. b. and c. until the determined errors for the voxels is below a predetermined threshold indicating trained machine learned algorithms.
37. A system for creating digital surface models, comprising:
   one or more non-transitory computer readable medium storing computer executable code that when executed by one or more computer processors causes the one or more computer processors to:
   create a digital surface model of a desired geographic area from one or more desired digital images depicting the desired geographic area, the one or more desired digital images not required to be part of stereo image pairs, the digital surface model depicting objects having a first feature beyond that depicted in the one or more desired digital images, by utilizing trained machine learning algorithms, the trained machine algorithms having been trained by iteratively performing, until a predetermined error level is achieved:
   receiving one or more first digital images depicting one or more of the objects in a first geographic area separate from the desired geographic area, the objects lacking the first feature;
   generating, utilizing initial machine learning algorithms, a first digital surface model from the one or more first digital images;
   determining error of the first digital surface model by comparing, utilizing the initial machine learning algorithms, elevations of voxels in the first digital surface model to elevations of voxels in a predetermined second digital surface model of the objects, the predetermined second digital surface model created using one or more of LiDAR data points and stereo image pairs depicting the objects having the first feature; and
   adjusting, via back-propagation, the initial machine learning algorithms based on determined error from the comparison, the determined error indicative of the first feature.

What is claimed is:

1. A method for creating digital surface models, comprising:
a. generating, with one or more machine learning algorithms, a candidate digital surface model of a portion of a first geographic area with one or more first images from a set of first images, the candidate digital surface model having a plurality of voxels with at least some of the voxels identifying a location within the first geographic area and having an elevation value, the set of first images depicting at least a portion of the first geographic area with a first characteristic;
b. comparing elevation values for voxels of the candidate Digital Surface Model to corresponding elevation values for voxels of a predetermined Digital Surface Model of the first geographic area to determine an error for the voxels of the candidate Digital Surface Model, the predetermined Digital Surface Model created with a set of second images of the first geographic area having a second characteristic including features beyond that provided with the set of first images having the first characteristic;
c. adjusting, via back-propagation, the one or more machine learning algorithms based on the determined error for the voxels of the candidate Digital Surface Model; and
d. repeating a. b. and c. until the determined errors for the voxels is below a predetermined threshold indicating trained machine learned algorithms; and
e. generating with the trained machine learning algorithms, a new Digital Surface Model using a set of third images depicting a second geographic area.

2. The method for creating digital surface models of claim 1, wherein the first geographic area covers a different geographic region than the second geographic area.

3. The method for creating digital surface models of claim 1, wherein the first geographic area and the second geographic area have similar features.

4. The method for creating digital surface models of claim 1, wherein the first characteristic is deciduous trees without leaves, and the second characteristic including features beyond that provided with the set of first images having the first characteristic is deciduous trees with leaves.

5. The method for creating digital surface models of claim 1, wherein the first characteristic is one or more objects having an obstruction, and the second characteristic including features beyond that provided with the set of first images having the first characteristic is one or more objects without the obstruction.

6. The method for creating digital surface models of claim 1, wherein one or more of the first images, the second images, and the third images are geo-referenced images having one or more pixels having associated geolocation data.

7. The method for creating digital surface models of claim 6, further comprising:
incorporating terrain elevation into one or more of the candidate Digital Surface Model, the predetermined Digital Surface Model, and the new Digital Surface Model.

8. The method for creating digital surface models of claim 7, wherein incorporating terrain elevation comprises utilizing the geolocation data of the geo-reference images to associate corresponding terrain elevation data with the one or more pixels.

9. A system for creating digital surface models, comprising:
one or more non-transitory computer readable medium storing computer executable code that when executed by one or more computer processors causes the one or more computer processors to:
a. generate, with one or more machine learning algorithms, a candidate Digital Surface Model of a portion of a first geographic area with one or more first images from a set of first images, the candidate Digital Surface Model having a plurality of voxels with at least some of the voxels identifying a location within the first geographic area and having an elevation value, the set of first images depicting at least a portion of the first geographic area with a first characteristic;
b. compare elevation values for voxels of the candidate Digital Surface Model to corresponding elevation values for voxels of a predetermined Digital Surface Model of the first geographic area to determine an error for the voxels of the candidate Digital Surface Model, the predetermined Digital Surface Model created with a set of second images of the first geographic area having a second characteristic including features beyond that provided with the set of first images having the first characteristic;
c. adjust, via back-propagation, the one or more machine learning algorithms based on the determined error for the voxels of the candidate Digital Surface Model; and
d. repeat a. b. and c. until the determined errors for the voxels is below a predetermined threshold indicating trained machine learned algorithms; and
e. generate with the trained machine learning algorithms, a new Digital Surface Model using a set of third images depicting a second geographic area.

10. The system for creating digital surface models of claim 9, wherein the first geographic area covers a different geographic region than the second geographic area.

11. The system for creating digital surface models of claim 9, wherein the first geographic area and the second geographic area have similar features.

12. The system for creating digital surface models of claim 9, wherein the first characteristic is deciduous trees without leaves, and the second characteristic including features beyond that provided with the set of first images having the first characteristic is deciduous trees with leaves.

13. The system for creating digital surface models of claim 9, wherein the first characteristic is one or more objects having an obstruction, and the second characteristic including features beyond that provided with the set of first images having the first characteristic is one or more objects without the obstruction.

14. The system for creating digital surface models of claim 9, wherein one or more of the first images, the second images, and the third images are geo-referenced images having one or more pixels having associated geolocation data.

15. The system for creating digital surface models of claim 9, the one or more non-transitory computer readable medium storing computer executable code that when executed by one or more computer processors causes the one or more computer processors to:
incorporate terrain elevation into one or more of the candidate Digital Surface Model, the predetermined Digital Surface Model, and the new Digital Surface Model.

16. The system for creating digital surface models of claim 15, wherein one or more of the first images, the second images, and the third images are geo-referenced images having one or more pixels having associated geolocation data, and wherein incorporating terrain elevation comprises utilizing the geolocation data of the geo-referenced images to associate corresponding terrain elevation data with the one or more pixels.

17. The system for creating digital surface models of claim 12, the one or more non-transitory computer readable medium storing computer executable code that when executed by one or more computer processors causes the one or more computer processors to:
determine solar access values for a roof based on the new Digital Surface Model, and calculate a ray between a sun position and the roof as affected by the new Digital Surface Model in relation to a path of the ray.

18. The system for creating digital surface models of claim 9, wherein the machine learning algorithms comprise Generative Adversarial Networks (GANs).

19. A system for creating digital surface models, comprising:
one or more non-transitory computer readable medium storing computer executable code that when executed by one or more computer processors causes the one or more computer processors to:
create a digital surface model of a desired geographic area from one or more desired digital images depicting the desired geographic area, the digital surface model depicting objects having a first characteristic including features beyond that depicted in the one or more desired digital images, by utilizing trained machine learning algorithms, the trained machine algorithms having been trained by:
a. generating, with one or more original machine learning algorithms, a candidate Digital Surface Model of a portion of a first geographic area with one or more first images from a set of first images, the candidate Digital Surface Model having a plurality of voxels with at least some of the voxels identifying a location within the first geographic area and having an elevation value, the set of first images depicting at least a portion of the first geographic area with the first characteristic;
b. determining error for the voxels of the candidate Digital Surface Model by comparing elevation values for voxels of the candidate Digital Surface Model to corresponding elevation values for voxels of a predetermined Digital Surface Model of the first geographic area, the predetermined Digital Surface Model created with a set of second images of the first geographic area having a second characteristic including features beyond that provided with the set of first images having the first characteristic;
c. adjusting, via back-propagation, the one or more machine learning algorithms based on the determined error for the voxel of the candidate Digital Surface Model; and
d. repeating a. b. and c. until the determined errors for the voxels is below a predetermined threshold indicating trained machine learned algorithms.

20. The system for creating digital surface models of claim 19, wherein the one or more desired digital images are not required to be part of stereo image pairs.
